(19) United States
(12) Patent Application Publication
(10) Pub. No.: US 2008/0217816 A1
(43) Pub. Date: Sep. 11, 2008

(54) Production Method for Sole Plate

(76) Inventors: Kazukiyo Hemmi, Fukuoka (JP); Hiroko Miyachi, Fukuoka (JP)

Correspondence Address: JORDAN AND HAMBURG LLP, 122 EAST 42ND STREET, SUITE 4000, NEW YORK, NY, 10168, US

(21) Appl. No.: 10/569,585

(22) PCT Filed: Apr. 11, 2005
(86) PCT No.: PCT/JP05/07040

§ 371 Date: Mar. 27, 2006

(30) Foreign Application Priority Data
Nov. 18, 2004 (JP) 2004-334772
Dec. 10, 2004 (JP) 2004-358935

(51) Int. Cl. B29C 51/00

(52) U.S. Cl. 264/319

(57) ABSTRACT

Disclosed is a sole plate production method, which comprises the steps of heating a sole-plate substrate material made of thermoplastic resin, pressing the heated substrate material relative to a foot sole of a human to prepare a sole-plate substrate (1) having a shape corresponding to a sole arch of the foot sole, and producing a sole plate using the obtained substrate (1). In this method, the step of pressing the heated substrate material relative to the foot sole includes pushing in a portion of the substrate material corresponding to an apex of a lateral arch of the sole arch to allow the substrate to be formed with a convex portion (2) corresponding to the apex of the lateral arch. The method of the present invention makes it possible to efficiently produce a sole plate having the convex portion conformable to an apex of a lateral arch of a foot sole.

### TECHNICAL FIELD

The present invention relates to a production method for a sole plate usable as a shoe sole, a shoe insole or the like.

### BACKGROUND ART

As shown in FIG. 8, in the foot soles of human beings walking on two legs, an arch-shaped structure, so-called “sole arch”, is formed between a heel bone 16 and a sesamoid bone 17. The sole arch includes a pair of longitudinal (inner and outer) arches and a lateral arch, which form a 3-dimensionally-arcing curved surface defined by three lines connecting the foot heel, small toe and big toe draw, as shown in FIG. 9.

This sole arch supports the human body weight through the skull, cervical spine, lumbar spine, pelvis, thigh bone, stifle bone and lower-thigh bone, to play a significantly important roll in walking upright. Thus, a deformation of the sole arch serving as a support base of the body makes it difficult to maintain a standing posture from the sole to the head. This leads to a symptom, such as knee pain, lumbar pain or crouchback, and a resulting posture apt to press the internal organs could be factors causing various diseases. The sole arch serves as a spring in walking to absorb a shock in walking and disperse a dynamic load to be imposed in a level several times greater than the body weight when a person starts moving. Further, the sole arch developed in a normal state serves as a pump, so-called “third heart”, which can generate upward streams of blood (venous blood) with each step.

As above, the maintenance of a normal sole arch is critically important to human health. As measures for maintaining a sole arch, a sole plate having a convex/concave portion corresponding to the sole arch has been used as a shoe sole or insole, as disclosed, for example, in Japanese Registered Utility Model No. 3055368 (Patent Publication 1).

While this sole plate can be used as an effective means for maintaining or forming a sole arch, the intended effect can be achieved only if the sole plate is designed to conform to a shape of the foot sole of a user. In particular, it is important to allow a convex portion of the sole plate to be located at an apex of a lateral arch (at a position corresponding to the plantar interosseous muscle).

Heretofore, such a position adjustment has been performed based on experience of an engineer or artisan through a trial and error process of measuring a shape of the foot sole of a user using a foot printer or the like, doing a user's trial use many times and adjusting the position based on foot comfort or uncomfortable feel during the trial use. Thus, this conventional method is requited to spend a lot of time and effort.

Moreover, a sole arch is not always maintained in the same shape. Specifically, a heel bone 16 and a sesamoid bone 17 located, respectively, at opposite ends of the sole arch are connected to one another by a ligament, so-called “long plantar ligament”, indicated by the reference numeral 18 in FIG. 10. The long plantar ligament 18 elongates and contracts during exercise, such as walking, and the shape of the sole arch is changed in conjunction with the elongation and contraction. This long plantar ligament 18 also plays the most important roll in maintaining a sole arch. Thus, it is important to design a sole plate with the stretchability of the long plantar ligament 18.

The sole plate disclosed in the above Patent Publication 1 is not designed with the stretchability of a long plantar ligament. Thus, the long plantar ligament is pressed by the convex portion of the sole plate corresponding to the sole arch, every time the sole arch has a lowered height in conjunction with elongation of the long plantar ligament during exercise, such as walking. If such a press is repeated thousands or tens of thousands of times by long hours of walking or the like, the stretchability (flexibility) of the long plantar ligament will be lost with fatigue to cause difficulty in maintaining a shape of the sole arch.

### DISCLOSURE OF THE INVENTION

In view of the above problems, it is therefore an object of the present invention to provide a method of efficiently producing a sole plate which has a convex portion capable of conforming to a shape of the foot sole of a user while being positioned at an apex of a lateral arch of the foot sole.

It is another object of the present invention to provide a method of efficiently producing a sole plate capable of avoiding pressing a long plantar ligament during exercise, such as walking.

It is still another object of the present invention to provide a method of efficiently producing a sole plate capable of forming and/or maintaining a healthy sole arch.

In order to achieve the above object, the present invention provides a sole plate production method comprising the steps of heating a sole-plate substrate material made of thermoplastic resin, pressing the heated substrate material relative to a foot sole of a human to prepare a sole-plate substrate having a shape corresponding to a sole arch of the foot sole, and producing a sole plate using the obtained substrate. In this method, the step of pressing the heated substrate material relative to the foot sole includes pushing in a portion of the substrate material corresponding to an apex of a lateral arch of the sole arch to allow the substrate to be formed with a convex portion corresponding to the apex of the lateral arch.

In the sole plate production method of the present invention, the convex portion corresponding to the apex of the lateral arch may be formed using a spatula having a convexly-curved end. Specifically, a portion of the substrate material corresponding to the apex of the lateral arch is pressed by an operator's thumb to determine a position of the portion, and the end of the spatula is brought into contact with the determined portion of the substrate material to push in the portion so as to allow the substrate to be formed with a convex portion corresponding to the apex of the lateral arch. The convex portion of the substrate may be formed with a slit which extends in a longitudinal direction of the substrate and have an open end at a toe-side end of the substrate.

In the sole plate production method of the present invention, before pressing the heated substrate material relative to the foot sole, a depression forming member may be attached onto a long plantar ligament region of the sole arch, and then the heated substrate material may be pressed relative to the foot sole to allow the substrate to be formed with a depression corresponding to the depression forming member.

In the sole plate production method of the present invention, when the heated substrate material is pressed relative to the foot sole, opposite side portions of the substrate martial may be pressed, respectively, onto opposite side regions of the foot sole to extend upward so as to allow the substrate to be formed with a pair of side supports. Preferably, the side supports are formed in a portion of the substrate corresponding only to a region of the foot sole ranging from a first metatarsal bone to a fifth metatarsal bone. Further, a notch may be formed in each of the side supports at a position closer to a toe-side end of the substrate relative to an immovable joint region of the foot sole.

In the sole plate production method of the present invention, the substrate material is preferably pre-formed to have an outside dimension capable of being formed directly into a final shape of the substrate.

According to the present invention, the heated substrate material made of thermoplastic resin is pressed relative to a foot sole of a human to prepare a sole-plate substrate having a shape corresponding to a sole arch of the human. Thus, a sole plate conformable to a shape of the foot sole of a user can be readily obtained. In addition, a portion of the substrate material corresponding to an apex of a lateral arch of the sole arch can be pushed in to allow the substrate to be readily formed with a convex portion conformable to the apex of the lateral arch. In this way, the convex portion corresponding to the lateral arch can be positively formed in the substrate at an adequate position. Thus, a sole plate produced using the substrate can maintain a healthy lateral arch or correct a deformed lateral arch to allow the sole arch to fulfill its original functions so as to contribute to health maintenance/promotion.

In addition to the convex portion, the side supports can be formed in the sole plate to reliably maintain or correct the lateral arch.

Further, according to the present invention, the depression can be formed in the substrate accurately and readily at a position corresponding to a long plantar ligament region of the sole arch. Thus, a sole plate having the depression can be efficiently produced. This sole plate with the depression may be used as a shoe insole or the like to avoid pressing against the long plantar ligament during exercise so as to reduce fatigue of the long plantar ligament even after long hours of walking or the like to form and maintain a healthy sole arch.

### BRIEF DESCRIPTION OF DRAWINGS

FIG. 1 shows a sole-plate substrate obtained through a method of the present invention, wherein FIG. 1(a) is a perspective view of the substrate, and FIG. 1(b) is a sectional view taken along the line A-A in FIG. 1(a).

FIG. 2 is a top plan view showing a starting material of the substrate in FIG. 1.

FIG. 3 is a perspective view of a spatula for use in forming a convex portion in the substrate.

FIG. 4 is a top plan view showing a foot sole of a human.

FIG. 5 is a perspective view of a depression forming member attached on a long plantar ligament region of a sole arch.

FIG. 6 shows a sole plate as an end product, wherein FIGS. 6(a) and 6(b) are, respectively, a perspective front view and a perspective back view of the sole plate, and FIG. 6(c) is a sectional view taken along the line B-B in FIG. 6(a).

FIG. 7 shows another sole-plate substrate obtained through a method of the present invention, wherein FIG. 7(a) is a perspective view of the substrate, and FIG. 7(b) is a sectional view taken along the line C-C in FIG. 7(a).

FIG. 8 is a side view showing a foot sole of a human.

FIG. 9 is an explanatory diagram showing a foot sole of a human.

FIG. 10 is an explanatory diagram showing a sole arch of a human.

### BEST MODE FOR CARRYING OUT THE INVENTION

With reference to the accompanying drawings, an embodiment of the present invention will now be described.

### First Embodiment

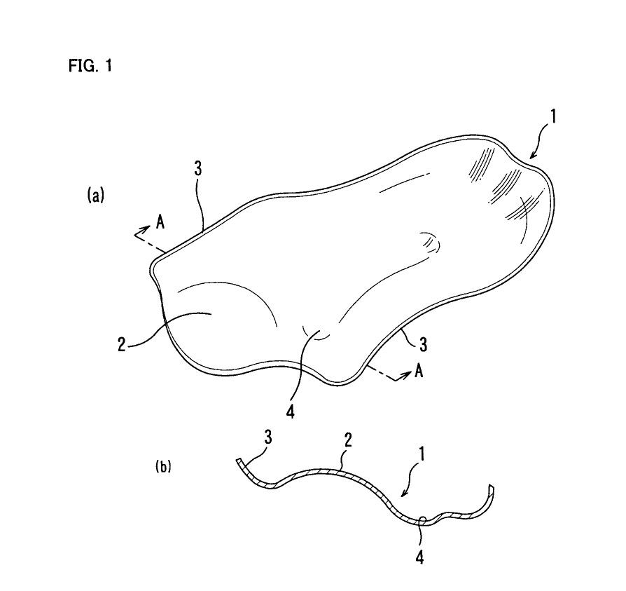

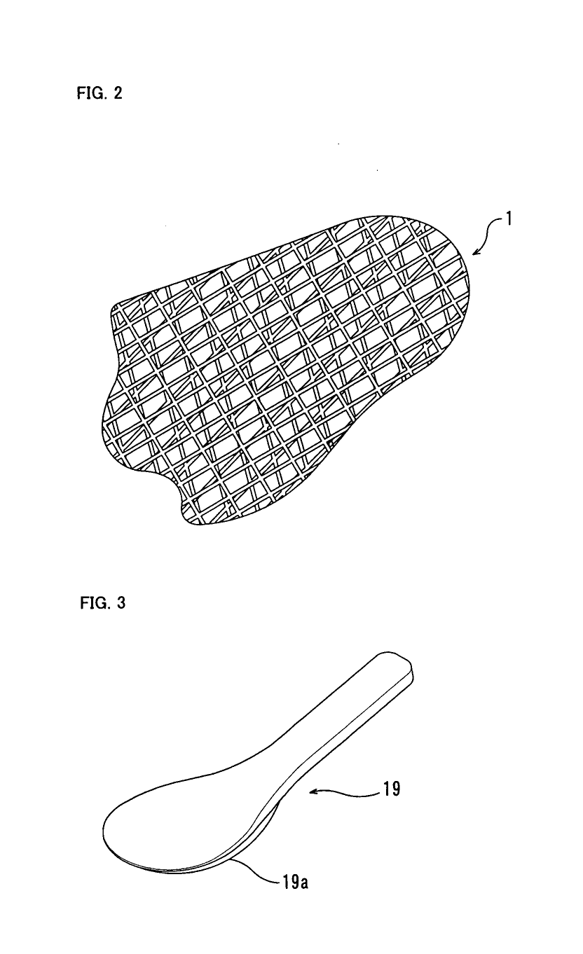

FIG. 1 shows a sole-plate substrate obtained through a method of the present invention, wherein FIG. 1(a) is a perspective view of the substrate, and FIG. 1(b) is a sectional view taken along the line A-A in FIG. 1(a). The substrate illustrated in FIG. 1 is prepared from a starting material having a shape as shown in FIG. 2. This substrate material is made of thermoplastic resin, and pre-formed through a punching process to have an outer dimension capable of being formed directly into a final shape of the substrate illustrated in FIG. 1. That is, the shape of the substrate material corresponds to a shape after developing (flattening out) the substrate illustrated in FIG. 1. This substrate material can be heated by hot water of about 70° C. to have a thermal plasticity capable of being deformed when pressed onto a foot sole of a human as described later. While the substrate material in FIG. 2 has a mesh structure, it may be pre-formed into a thin-plate shape.

The substrate 1 illustrated in FIG. 1 has a shape corresponding to a sole arch of a human (user). The shape of the substrate 1 includes a convex portion 2 formed in a position corresponding to an apex of a lateral arch of the sole arch, a pair of side supports 3 formed in conformity, respectively, with opposite side regions of the foot sole to extend upward, and a depression 4 formed in a position corresponding to a long plantar ligament region of the foot sole.

The substrate illustrated in FIG. 1 is obtained by heating and softening the substrate material illustrated in FIG. 2 using hot water, and pressing the heated substrate material onto the foot sole of the user. When the heated substrate material is pressed onto the foot sole, the user may wear a sock.

More specifically, when the substrate material is pressed onto the foot sole, a portion of the substrate material corresponding to the apex of the lateral arch is pushed in using a finger or a stick, to form the convex portion 2 corresponding to the apex of the lateral arch. Preferably, a spatula 19 having a convexly-curved end 19a, as shown in FIG. 3 is used for forming the convex portion 2. Specifically, the convex portion 2 is formed by bringing the end 19a of the spatula 19 into contact with a portion of the substrate material corresponding to the apex of the lateral arch of the sole arch to push in the portion.

Further, when the substrate material is pressed onto the foot sole, opposite side portions of the substrate material are pressed, respectively, onto opposite side regions of the foot sole to extend upward, to form the pair of side supports 3. In this way, the side supports 3 can be formed in conformity to the shape of an actual foot sole. The substrate illustrated in FIG. 1 is formed with the pair of side supports 3 in such a manner as to be continuously connected to one another through a rising portion formed in a heed end thereof.

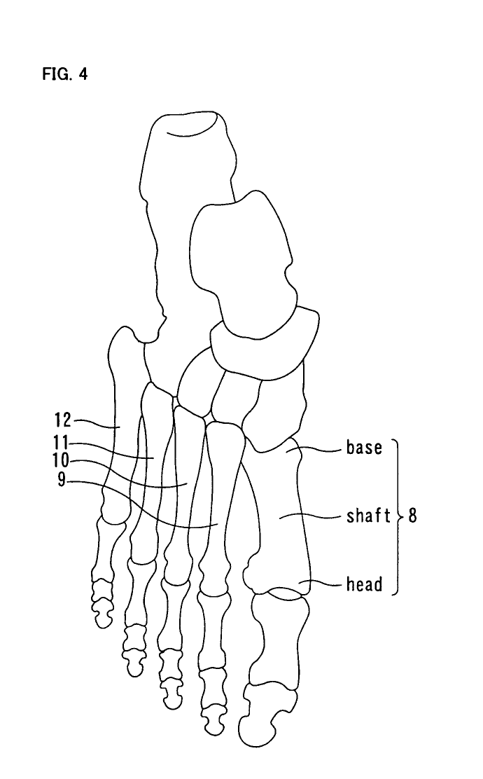

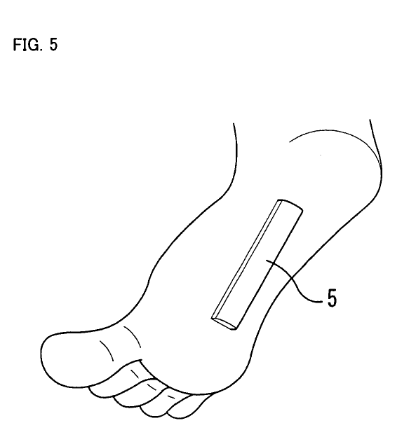

As shown in FIG. 4, a foot sole of a human has first to fifth metatarsal bones. As representatively shown by the first metatarsal bone 8, each of the first to fifth metatarsal bones consists of “base”, “shaft” and “head”. If the side supports 3 are formed in a portion of the substrate corresponding to the heads of the first metatarsal bone 8 and the fifth metatarsal bone 12 or closer to a toe of the foot sole relative to these heads, they will hinder walking. Thus, the side supports are formed in only a portion of the substrate which extends from a position corresponding to the shafts of the first and fifth metatarsal bones 8, 12 toward the heel end of the substrate, to have a shape capable of wrapping around regions of the foot sole corresponding to the first and fifth metatarsal bones 8, 12.

Further, in order to form the depression 4 in a portion of the substrate corresponding to the long plantar ligament region of the sole arch, a depression forming member 5 is attached onto the long plantar ligament region of the sole arch as shown in FIG. 5 before the heated substrate material is pressed onto the foot sole. Then, the heated substrate material made of thermoplastic resin is pressed onto the foot sole of the user. In this way, the depression 4 corresponding to the depression forming member 5 is formed in the substrate. Generally, it is difficult to find a position of the long plantar ligament in a normal state when the long plantar ligament contracts. Thus, when the depression forming member 5 is attached onto the foot sole, the long plantar ligament may be stretched, for example, by bending a big toe, to facilitate finding the position of the long plantar ligament, and then the depression forming member 5 may be attached thereonto. For example, the depression forming member 5 is made of a hard material having flexibility, such as hard plastic, and formed to have a shape (width, length) analogous to that of the long plantar ligament.

The apex of the lateral arch defining the convex portion 2 is located outward relative to the long plantar ligament in FIG. 10 and in a position corresponding to the shafts of the third metatarsal bone 10 and the fourth metatarsal bone 11. Thus, practically, a position of the apex of the lateral arch can be readily determined by touching a portion of the substrate material located outward relative to the depression forming member 5.

A sole plate is produced using the substrate 1 prepared as shown in FIG. 1 in the above manner, and subjected to fine adjustment for shape and/or finish processing according need.

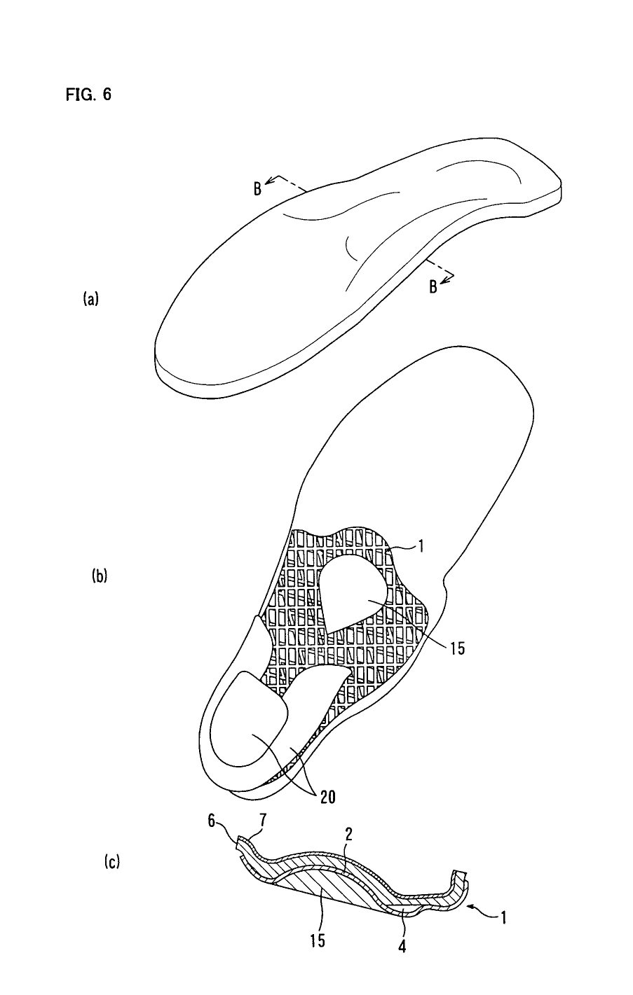

FIG. 6 shows one example of a sole plate as an end product, wherein FIGS. 6(a) and 6(b) are, respectively, a perspective front view and a perspective back view of the sole plate, and FIG. 6(c) is a sectional view taken along the line B-B in FIG. 6(a). The sole plate illustrated in FIG. 6 comprises the substrate 1, a cushioning layer 6 formed on the substrate 1, a leather 7 attached on a surface of the cushioning layer 6, a cushioning material 15 filled in a lower space defined by the convex portion of the substrate 1. Further, a soft rubber member 20 is attached on a heel region of a bottom surface of the substrate 1 to prevent undesirable movement, such as wobbling, of the sole plate during use, so as to provide enhanced stability. This soft rubber member may be attached onto any other suitable region other than that illustrated in FIG. 6(b) according to need. In the sole plate illustrated in FIG. 6, the depression 4 is left as a void, it may be filled with a soft material having softness greater than that of the cushioning layer 6.

This sole plate may be used as a shoe insole. In this case, the sole plate formed with the convex portion 2 corresponding to a lateral arch and the pair of side supports 3 makes it possible to form a lateral arch based on the convex portion 2 during exercise while preventing deformation in the lateral arch based on the side supports 3, so as to form and maintain a healthy sole arch. Thus, the sole plate can be effectively utilized to improve troubles of feet, such as fallen arches and hallux valgus.

In addition, the use of the sole plate having excellent fit or conformability makes it possible to step on the ground while imposing the entire body weight on the plantar arch (sole arch). Thus, a repulsive force acting from the ground onto the sole plate and the rebound of the long plantar ligament are simultaneously generated to allow a user to move his/her knee upward comfortably and walk ahead at higher speed. Further, the repulsive force acting from the ground onto the sole plate serves as a pump, so-called “third heart”, which can generate upward streams of venous blood which has to be returned against gravitational force. This pumping action also makes an effect on the calf, so-called “second heart”, to improve the circulation of the blood so as to lead relief of twitch or edema. Furthermore, the sole plate can be formed as an individualized sole arch support to provide a stable support base allowing knees, hip joints, lumbar, spine, neck, etc., to be stabilized. Thus, it can be expected to prevent troubles in various regions due to wobbling in the support base.

In this embodiment, the depression 4 formed in a position corresponding to the long plantar ligament makes it possible to eliminate the risk that a sole plate presses the long plantar ligament during exercise, so as to reduce fatigue of the long plantar ligament even after long hours of

### Second Embodiment

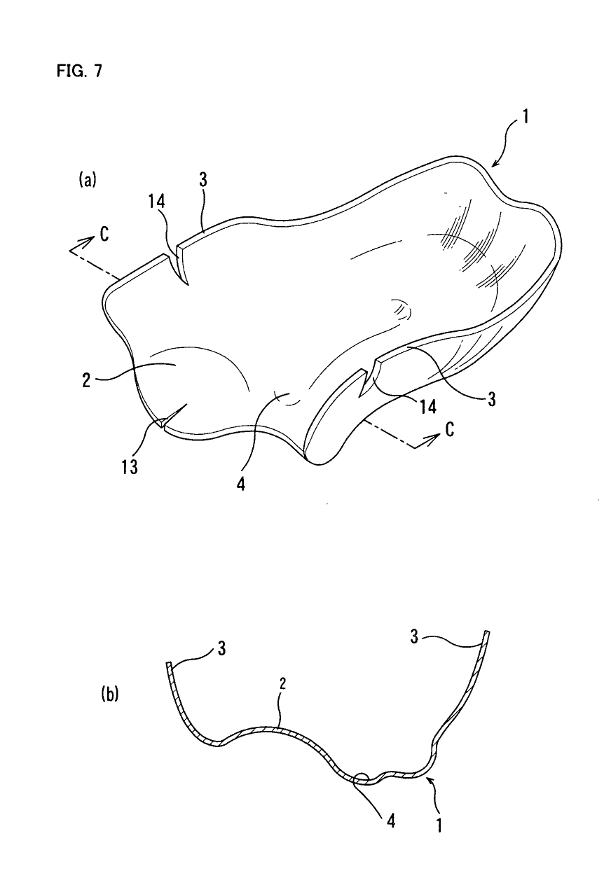

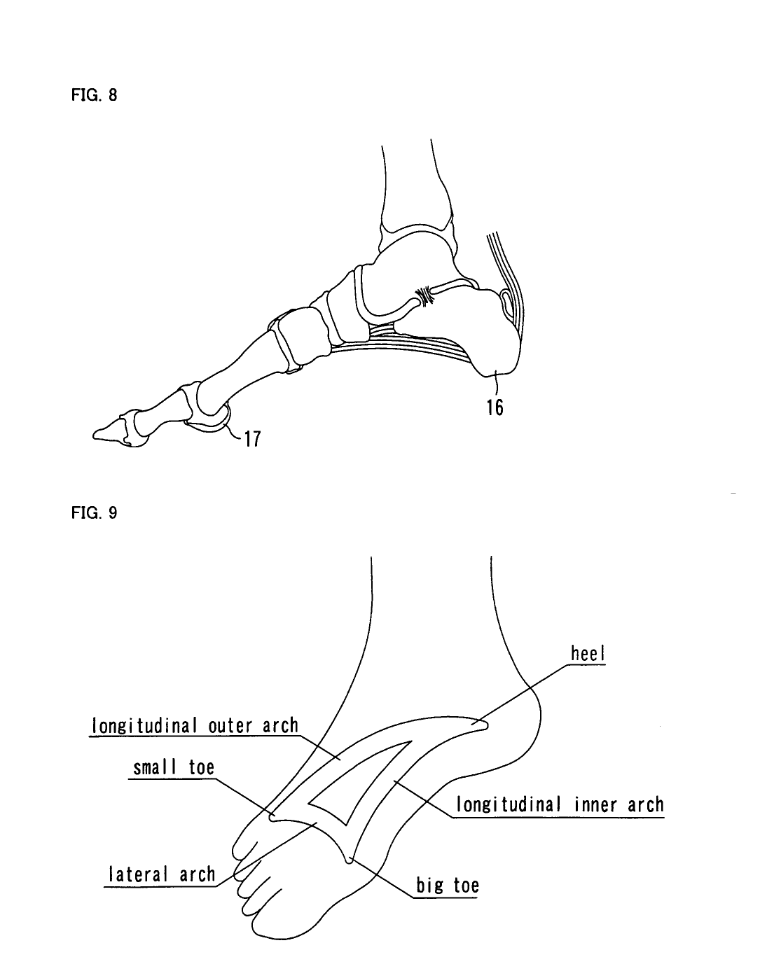

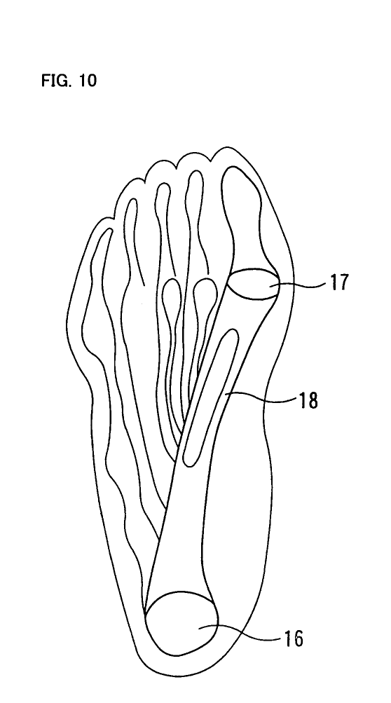

FIG. 7 shows another example of a sole-plate substrate obtained through the method of the present invention, wherein FIG. 7(a) is a perspective view of the substrate, and FIG. 7(b) is a sectional view taken along the line C-C in FIG. 7(a). This sole-plate substrate comprises a convex portion 2 formed with a slit 13, a pair of side supports 3 each formed with a notch 14, and a depression 4. Each of the convex portion 2, the side supports 3 and the depression 4 is formed in fundamentally the same manner as that in the first embodiment, except that each of the side supports 3 is formed to have a lager height than that in the first embodiment.

The slit 13 is formed in the convex portion 2 to extend in a longitudinal direction of the substrate 2 and have an open end at a toe-side end of the convex portion 2. The notch 14 is formed in each of the side supports 3 at a position slightly closer to the toe-side end of the substrate 2 relative to an immovable joint in a heel region of the foot sole.

When the convex portion 2 is pressed by the foot sole during exercise, the slit 13 formed in the convex portion 2 allows the side supports 3 to be rotated about an axis passing through the slit 13 in a direction wrapping around opposite sides of the foot sole. This makes it possible to more effectively form and maintain a sole arch.

The notch 14 formed in each of the side supports 3 at a position closer to the toe-side end of the substrate 2 relative to the immovable joint region of the foot sole provides flexibility in a portion of the substrate closer to the toe-side end relative to the immovable joint region. This makes it possible to form and maintain a sole arch without hindering exercise, such as walking.

The sole-plate substrate material used in the above embodiments is made of thermoplastic resin, and pre-formed through a punching process to have a plate shape with an outer dimension capable of being formed directly into a final shape of a sole-plate substrate, as shown in FIG. 2. Alternatively, a rectangular-shaped plate member made of thermoplastic resin may be used as a sole-plate substrate material. In this case, the plate member may be formed into a given shape, and then an unnecessary portion of the plate member may be cut away to prepare a sole-plate substrate. However, this technique is required to take additional time and effort for cutting away an unnecessary portion after forming the plate member into a given shape. Thus, a sole-plate substrate material is preferably pre-formed to have an outer dimension capable of being formed directly into a final shape of a sole-plate substrate so as to eliminate or minimize the need for cutting away an unnecessary portion after a shaping process.

### INDUSTRIAL APPLICABILITY

The present invention can be applied to production of a sole plate for use as a shoe sole or a shoe insole, and a sole plate to be used by attaching onto or placing on a surface of a clog or sandal. In application to a sandal, a sole plate may be formed with a notch, cutout etc., to be attached to a sandal thong.

What is claimed is:

1. A sole plate production method comprising the steps of heating a sole-plate substrate material made of thermoplastic resin, pressing said heated substrate material relative to a foot sole of a human to prepare a sole-plate substrate having a shape corresponding to a sole arch of said foot sole, and producing a sole plate using said obtained substrate, wherein:
said step of pressing the heated substrate material relative to the foot sole includes pushing in a portion of said substrate material corresponding to an apex of a lateral arch of said sole arch to allow said substrate to be formed with a convex portion corresponding to the apex of said lateral arch.

2. The sole plate production method as defined in claim 1, which further includes the step of providing a spatula having a convexly-curved end, wherein said step of pressing the heated substrate material relative to the foot sole includes bringing said end of said spatula into contact with the portion of said substrate material corresponding to an apex of a lateral arch of said sole arch to push in said portion so as to allow said substrate to be formed with a convex portion corresponding to the apex of said lateral arch.

3. The sole plate production method as defined in claim 1, which further includes the step of forming a slit in said convex portion of said substrate to extend in a longitudinal direction of said substrate and have an open end at a toe-side end of said substrate.

4. The sole plate production method as defined in claim 1, which further includes the step of attaching a depression forming member onto a long plantar ligament region of said sole arch before said step of pressing the heated substrate material relative to the foot sole, and then pressing the heated substrate material relative to the foot sole to allow said substrate to be formed with a depression corresponding to said depression forming member.

5. The sole plate production method as defined in claim 1, wherein said step of pressing the heated substrate material relative to the foot sole includes pressing opposite side portions of said substrate martial, respectively, onto opposite side regions of said foot sole to extend upward so as to allow said substrate to be formed with a pair of side supports.

6. The sole plate production method as defined in claim 5, wherein said side supports are formed in only a portion of said substrate which extends from a position corresponding to respective shafts of first and fifth metatarsal bones of the foot sole toward a heel end of said substrate.

7. The sole plate production method as defined in claim 5, which further includes the step of forming a notch in each of said side supports at a position closer to a toe-side end of said substrate relative to an immovable joint region of said foot sole.

8. The sole plate production method as defined in either one of claims 1 to 7, wherein said substrate material is pre-formed to have an outside dimension capable of being formed directly into a final shape of said substrate.
